(19) United States
(12) Patent Application Publication
(10) Pub. No.: US 2025/0283496 A1
(43) Pub. Date: Sep. 11, 2025

(54) REINFORCED POLYMER FASTENER AND RELATED METHOD OF MANUFACTURE

(71) Applicant: Kathleen Nieuwenhuys, Krugersdorp (ZA)

(72) Inventor: Kathleen Nieuwenhuys, Krugersdorp (ZA)

(21) Appl. No.: 19/073,465

(22) Filed: Mar. 7, 2025

(30) Foreign Application Priority Data
Mar. 7, 2024 (ZA) 2024/01910

(51) Int. Cl. F16B 15/08; B29C 45/00; B29C 48/00; B29C 48/88; B29L 31/00; F16B 15/06

(52) U.S. Cl. CPC F16B 15/08; B29C 45/0005; B29C 45/006; B29C 48/0021; B29C 48/022; B29C 48/911; B29C 48/919; F16B 15/06; B29K 2995/0077; B29L 2031/7286

(57) ABSTRACT

A collated strip of polymer fasteners is provided, the collated strip comprising a plurality of spaced apart polymer fasteners, each made from a polymer material, each polymer fastener comprising a head and a shank extending therefrom, the shank terminating at an end; and a connector integrally formed with, and extending transversely across, the shanks of each polymer fastener, the connector being arranged to separate the fasteners, including the heads of each fastener, from each other. In an embodiment, a portion of the shank is threaded, the threaded portion of the shank being either screw-threaded or ring-threaded. The connector comprises a pair of spaced apart collating threads to integrally connect the shanks of the polymer fasteners together, to define the collated strip of polymer fasteners. In one version, the connector is made from the same polymer material as the polymer fasteners.

### CROSS REFERENCE TO RELATED APPLICATION

This application claims the benefit of South Africa Patent Application No. 2024/01910 filed Mar. 7, 2024, the entire disclosure of which is incorporated by reference.

### FIELD OF THE INVENTION

This invention relates to reinforced polymer fasteners and to a related collated strip of polymer fasteners. The invention extends to a method of manufacturing both individual polymer fasteners and the collated strip, all in a single process, for subsequent use in either a single, strip or coil form. The polymer fasteners may either be threaded (either screw-threaded or ring-threaded) or unthreaded (i.e. plain or smooth), and can optionally be used with a washer or seal, or with a sleeve or anchor.

### BACKGROUND OF THE INVENTION

Typical steel or metal nails are traditionally made using several conventional manufacturing steps, including wire drawing, nail making, polishing, threading (also known as ring shanking/threading or screw shanking/threading) and galvanising or hop dipped, if required. This will now be described in more detail with reference to FIG. 1.

FIG. 1 shows the typical manufacturing process 10 for mild steel wire from wire drawing to nail forming (with either a threaded shank or a smooth shank) to collation, in more detail. The process 10 includes a wire draw step 12, which includes the step of drawing mild steel rods down from standard sizes, including 5.5 mm, 6.5 mm, 8 mm and 10 mm, down to the required sizes. Once drawn, the next step is the making of the nail itself, as shown by block 14, which includes forming and/or defining the nail's head, shank and pointed (or flattened) tip. Once made, the nail is then usually polished, as shown by block 16, to remove excess oil, grease and draw soap from the nail. The nail may be left unthreaded, to define a plain nail with a smooth shank. Alternatively, the nail may be threaded, in a process known as ring or screw shanking or threading, as shown by block 18, to increase the withholding strength of the nail. The next step is typically a galvanizing step, as shown by block 20, in which the nail is dipped in an electro zinc, galvanizing or hot dip to ensure that the nail is protected against rust and corrosion. The final step is a collating step, as shown by block 22, in which a plurality of nails is assembled together with two lines of welding wire to define a collated strip of nails, to form a strip or coil that can be inserted into a collated nail tool or gun.

Traditional nail tool or guns use collated steel nails in the form of coil nails or strip nails, which are inserted into the magazine, depending on the collated tool used. The inserted nails need to have a head, shank and a point, to enable the nail tool or gun to be used.

A distinction may be made between a coil nail and strip nail. Coil nails come in a long, flexible coil of nails connected by wires or plastic strips; can hold more nails (typically 200-300) in a single load; are used in coil nailers, which can operate for longer periods without reloading; and are often used for larger projects or high-volume applications. Strip nails, on the other hand, come in shorter, straight strips of nails (typically 20-40 nails per strip); are held together by paper, plastic, or wire collation; are used in strip nailers, which require more frequent reloading; and are often preferred for smaller jobs or when more portability is needed. Traditional coil nailers are typically pneumatic power tools that use air to operate, thereby impacting the portability of such a tool or nailer.

Some of the downsides of this conventional manufacturing process include the underlying requirement for steel, the price and availability of which can at times be very erratic, and the need for several separate and sequential steps.

At a high level, collated polymer nails, as such, are not new. However, one of the differences between the known collated polymer nails and the present invention lies in the manufacturing process. Conventional collated polymer nails are made in a series of separate, sequential steps, which will now be described with reference to FIG. 2. As shown in FIG. 2, the traditional manufacturing process 30 of polymer collated nails comprises injection moulding using polymer pellets to form individual plain, unthreaded nails, as shown by block 32. Thereafter, the process 30 includes subsequently heating the nails, as shown by block 34, which is unavoidable, to then assemble paperboard or an alternative polymer to the nails in a subsequent collating step, as shown by block 96. The resulting arrangement is then cooled, to secure the assembled line, as shown by block 98. Significantly, currently available polymer nails are made for specific tools and cannot be used within traditional nail tools or guns. In addition, the sizes available are limited to a length of 57 mm resulting in a compression strength of around 20 000 psi (approximately 138 MPa), which limits the application of the nail to relatively softer wood types.

The aim of the present invention is thus to provide an integrated collated strip of fibre reinforced polymer nails, which can, for many to most applications, replace existing steel nails, and which can be manufactured in one single process and which can then also be used in traditional nail guns.

In terms of known prior art, U.S. Pat. No. 5,547,325 discloses a continuous nail pack made of ultra-high strength plastic composite materials, for example, thermoplastic or thermoset materials. The individual nails have sufficient compressive strength and a flexural modulus such that the nail may be used for nailing into commodity woods for construction, furniture making, or for building boats. However, the nail pack of U.S. Pat. No. 5,547,325 cannot be used in conventional wire-collated nail guns and, due to the manufacturing process used, the nails of the nail pack of U.S. Pat. No. 5,547,325 cannot be threaded (either screw-threaded or ring-threaded). In addition, the nails of U.S. Pat. No. 5,547,325 are typically 14, 15 or 16 gauge nails, with a maximum length of around 63.5 mm, which limits its practical application. This prior art refers to various wood types that the nail can penetrate but does not disclose the ability to penetrate metal sheet and wood, which is required in, for example, roof truss, roof sheeting and other roofing installations. In addition, the manufacturing process used in U.S. Pat. No. 5,547,325 does not allow for threading (either screw-threading or ring-threading), which reduces the nail's withholding strength.

Presently known strips of collated nails manufactured out of polymer or steel use kraft paper or other paperboard (or alternative polymer) materials to assemble the product into a strip form. To assemble the polymer or steel nail in a collated, strip form, a further process is unavoidable, namely securing the paperboard or polymer material to the polymer nails using a paper or plastic strip machine.

In another prior art document, U.S. Pat. No. 7,788,787B2, a method of assembling steel nails is provided. In particular, this prior art patent document provides a fastener assembly configured for use in an associated fastener driving tool for driving a fastener from the assembly into an associated substrate. The assembly includes a row of fasteners, each having a shank, arranged substantially parallel to each other. A collation system is formed from a plastic material that is molded onto and adhered to the fasteners. The plastic material is molded to define a collar portion substantially encircling the fastener shank and a connecting portion extending between and connecting adjacent collar portions. The plastic material is formulated from an adhesive polymer. When the fastener is driven from the driving tool, the collar portion remains adhered to the fastener such that the collar portion penetrates the substrate with the fastener. U.S. Pat. No. 7,788,787B2 extends to a method for making a fastener assembly includes the steps of arranging a plurality of fasteners in a row parallel to one another, preheating the plurality of fasteners to elevate the temperature of the fasteners, moulding a polymer material onto the preheated fasteners and between adjacent fasteners to form a plastic collation having a collar that captures or at least substantially encircles a shank of each fastener and a connecting portion between adjacent fasteners and cooling the strip to form the fastener assembly. The strip can then be post heat treated.

There is a need to provide a polymer nail product, in either a strip, coil or loose form, which can be produced using one, single process, discarding any other adhesive material including paperboard or polymer material heating to form a collation pattern. There is a further need to produce a collated nail that has high withholding strength to be used as an alternative to metal nails, not only in wood applications but also in metal applications, so that the nail becomes a viable alternative for steel nails, such as steel plate on wood in the example of roof panel applications. These nails can be used in an impact automatic tool or with the traditional method by using a manual process in the form of a hammer. The nails may also be used within a sleeve to further improve withholding strength, depending upon the required application. The loose, strip or coil nails can be used with a washer or without. As described above, traditional collated and loose wire nails are manufactured during various processes, including wire draw, nail making, polishing and threading (if required), and then a separate collating process using welding wire to assemble the nails. To prevent rust or corrosion, loose nails need to be galvanized after the polishing or threading process.

The aim of the present invention is thus to provide a fibre reinforced polymer fastener having high compression properties and withholding strength, which can be threaded and collated in one single process, for subsequent use in either a loose, strip or coil form, with or without a sleeve, anchor, washer or seal, and which can be used in wood on wood or wood on metal sheet applications.

### SUMMARY OF THE INVENTION

At a high level, the present invention provides a polymer fastener with high compression and withholding strength properties, and in particular a fibre reinforced polymer nail, which can be threaded (either screw-threaded or ring-threaded) in one single process, for subsequent use as loose, single nails. In addition, or alternatively, the fibre reinforced polymer nail may be collated in one single process, for subsequent use in either a strip or coil form. The underlying single process may use either calendar milling or injection moulding, with calendar milling and injection moulding being defined and described in more detail further below.

In particular, the present invention presents a fibre reinforced polymer fastener, such as a nail, manufactured from fibre reinforced polymer with a compression strength (tensile strength at break) of at least about 30,000 psi (approximately 207 MPa) and a flexural modulus of about 1890 ksi (approximately 13 MPa). The relatively high compression strength of the fibre reinforced polymer fastener of the present invention allows more applications to be completed successfully, including decking and pallet manufacturing using saligna or other relatively hard types of wood.

In particular, the fibre reinforced polymer fastener of the present invention can be manufactured in one single process and used in traditional nail guns.

The single manufacturing process may integrally include the steps of forming a thread on the shank of the nail (either a screw thread or a ring thread) to increase the nail's withholding strength, and provide rust and corrosion protection. The result is a composite nail that is corrosion and rust-free, within inherent self-extinguishing properties.

According to a first aspect of the invention, there is provided a collated strip of polymer fasteners, the collated strip comprising:
a plurality of spaced apart polymer fasteners, each made from a polymer material, each polymer fastener comprising a head and a shank extending therefrom, the shank terminating at an end; and
a connector integrally formed with, and extending transversely across, the shanks of each polymer fastener, the connector being arranged to separate the fasteners, including the heads of each fastener, from each other, to enable the collated strip of polymer fasteners to be used by a conventional nail gun.

In an embodiment, a portion of the shank is threaded, the threaded portion of the shank being either screw-threaded or ring-threaded. In one version, the head is raised relative to the shank and/or the head is itself threaded. In all of these versions, the end of the shank is either pointed or shaped.

In an embodiment, the connector comprises a pair of spaced apart collating threads to integrally connect the shanks of the polymer fasteners together, to define the collated strip of polymer fasteners.

In an embodiment, the connector is made from the same polymer material as the polymer fasteners.

In an embodiment, the polymer material is fibre reinforced, with each polymer fastener having a compression strength of at least about 30,000 psi (approximately 207 MPa) and a flexural modulus of at least about 1890 ksi (approximately 13 MPa).

According to a second aspect of the invention, there is provided a method of manufacturing a collated strip of polymer fasteners, the method comprising:
receiving a polymer material;
forming a plurality of spaced apart polymer fasteners from the polymer material, which includes the step of forming a head and forming a shank extending from the head, the shank terminating at an end, to define the polymer fastener; and
integrally forming a connector with the shanks of each polymer fastener, the connector extending transversely across the shanks of each polymer fastener, the connector being arranged to separate the fasteners, including the heads of each fastener, from each other, to enable the collated strip of polymer fasteners to be used by a conventional nail gun.

In an embodiment, the method includes the step of integrally threading at least a portion of the shank of each polymer fastener, the threaded portion of the shank being either screw-threaded or ring-threaded.

In an embodiment, the method includes the step of integrally forming a pair of spaced apart connectors with the shanks of each polymer fastener, to integrally connect the shanks of the polymer fasteners together, to define the collated strip of polymer fasteners.

In an embodiment, a portion of the shank is threaded, the threaded portion of the shank being either screw-threaded or ring-threaded. In one version, the head is raised relative to the shank and/or the head is itself threaded. In all of these versions, the end of the shank is either pointed or shaped.

In a first embodiment of the second aspect of the invention, the method comprises:
extruding raw plastic fibre reinforced polymer material to define an extruded polymer compound;
receiving at least one collating thread made from a polymer compound, the collating thread defining the connector; and
calendar milling the extruded polymer compound onto the at least one collating thread to define a strip of spaced apart polymer fasteners integral with the at least one collating thread.

In an embodiment, the method includes the step of water cooling and then air drying the strip of spaced apart polymer fasteners integral with the collating thread.

In an embodiment, the method includes the step of cutting the strip of spaced apart polymer fasteners integral with the collating thread, for subsequent use.

In a second embodiment of the second aspect of the invention, the method comprises injection moulding raw plastic polymer material, using a mould, to define the strip of spaced apart polymer fasteners integral with the connector.

In one version of the second embodiment, the mould defines both the polymer fasteners and the connector, to ultimately define an integrally moulded strip of spaced apart polymer fasteners integral with at least one connector.

In another version, the mould only defines the polymer fastener, with the method including the further step of receiving at least one collating thread, which defines the connector, into the mould, with the mould being arranged to integrally mould a strip of spaced apart polymer fasteners integral with at least one collating thread.

In an embodiment, once moulded, the method includes the step of conveying the strip of spaced apart polymer fasteners integral with the connector, and then cutting the strip of spaced apart polymer fasteners, for subsequent use.

According to a third aspect of the invention, there is provided an apparatus for forming a collated strip of polymer fasteners, the method comprising:
a receiver to receive a fibre reinforced polymer material;
first means to form a plurality of spaced apart polymer fasteners from the polymer material, each polymer fastener comprising a head and a shank extending from the head, the shank terminating at an end; and
second means to integrally form a connector to connect the shanks of each polymer fastener, the connector extending transversely across the shanks of each polymer fastener, the connector being arranged to separate the fasteners, including the heads of each fastener, from each other, to enable the collated strip of polymer fasteners to be used by a conventional nail gun.

In an embodiment, the apparatus includes third means to integrally form threading on at least a portion of the shank of each polymer fastener, the threaded portion of the shank being either screw-threaded or ring-threaded.

In an embodiment, the second means is arranged to form a pair of spaced apart connectors across the shanks of each polymer fastener, to integrally connect the shanks of the polymer fasteners together, to define the collated strip of polymer fasteners.

In an embodiment, a portion of the shank is threaded, the threaded portion of the shank being either screw-threaded or ring-threaded. In one version, the head is raised relative to the shank and/or the head is itself threaded. In all of these versions, the end of the shank is either pointed or shaped.

In a first embodiment of the third aspect of the invention, the receiver comprises an extruder to receive and extrude the polymer material, to define an extruded polymer compound, the extruder defining an outlet through which the extruded polymer compound can exit, with the apparatus further comprising a collating thread feeder to feed at least one collating thread, which defines the connector, towards the extruded polymer compound exiting the extruder, the collating thread being made from the same polymer material as the polymer fasteners, wherein the first and second means comprises a calendar milling roller arrangement to mould the extruded polymer compound onto the collating thread to define a strip of spaced apart polymer fasteners integral with the at least one collating thread.

In an embodiment, the apparatus includes a water-cooling arrangement to cool the strip of spaced apart polymer fasteners integral with the collating thread, and an air dryer to dry the strip of spaced apart polymer fasteners integral with the collating thread.

In an embodiment, the apparatus includes a cutting arrangement to cut the strip of spaced apart polymer fasteners integral with the collating thread, for subsequent use in either a strip or coil form.

In a second embodiment of the third aspect of the invention, the receiver comprises a hopper that is part of an injection moulding apparatus, the hopper being arranged to receive the polymer material.

In one version of the second embodiment, the apparatus comprises an injection moulding housing to accommodate a reciprocating barrel and screw for delivering an extruded polymer compound, wherein the first and second means comprises a mould for receiving the extruded polymer compound, with the mould defining both the polymer fasteners and the connector, to ultimately define an integrally moulded strip of spaced apart polymer fasteners integral with at least one collating thread.

In another version, the apparatus comprises an injection moulding housing to accommodate a reciprocating barrel and screw for delivering an extruded polymer compound, wherein the first and second means comprises a mould for receiving the extruded polymer compound, with the apparatus further comprising a collating thread feeder to feed at least one collating thread, which defines the connector, towards and into the mould, the mould being arranged to integrally mould a strip of spaced apart polymer fasteners integral with at least one collating thread.

In an embodiment, the collating thread feeder feeds two spaced apart collating threads into the mould, to enable the fasteners to be integrally attached to the two collating threads.

In an embodiment, the apparatus further includes a product conveyor to transport the moulded strip towards a cutting arrangement to cut the strip of spaced apart polymer fasteners integral with the collating thread.

In an embodiment, the apparatus further includes a collated nail coiler to coil the cut strip of spaced apart polymer fasteners integral with the collating thread.

According to a fourth aspect of the invention, there is provided a single polymer fastener made from a polymer material, each polymer fastener comprising a head and a shank integrally extending from the head, the shank terminating at an end, wherein at least a portion of the shank is threaded, the threaded portion of the shank being either screw-threaded or ring-threaded.

In one version, the head is raised relative to the shank and/or the head is itself threaded. In all of these versions, the end of the shank is either pointed or shaped.

In an embodiment, the polymer material is fibre reinforced, with the polymer fastener having a compression strength of at least about 30,000 psi (approximately 207 MPa) and a flexural modulus of at least about 1890 ksi (approximately 13 MPa).

### BRIEF DESCRIPTION OF DRAWINGS

The objects of this invention and the manner of obtaining them, will become more apparent, and the invention itself will be better understood, by reference to the following description of embodiments of the invention taken in conjunction with the accompanying diagrammatic drawing, wherein:

FIG. 1 shows a typical manufacturing process for mild steel wire collated nails;

FIG. 2 shows a typical manufacturing process for polymer collated nails;

FIG. 3 shows a single, plain fibre reinforced polymer nail, according to the invention;

FIG. 4 shows a single, threaded fibre reinforced polymer nail;

FIG. 5 shows a single, threaded fibre reinforced polymer nail but with a raised head;

FIG. 6 shows a single, threaded fibre reinforced polymer nail but with a threaded head;

FIG. 7 shows a single, threaded fibre reinforced polymer nail but with a split end;

FIG. 8 shows an integrated collated strip of reinforced polymer nails, in this case of the type shown in FIG. 1;

FIG. 9 shows a manufacturing apparatus and process to make any of the nails shown in FIGS. 3 to 7 and/or the integrated collated nail strip shown in FIG. 8 using calendar milling, according to a first embodiment of the present invention; and

FIG. 10 shows a manufacturing apparatus and process to make any of the nails shown in FIGS. 3 to 7 and/or the integrated collated nail strip shown in FIG. 8 using injection moulding, according to a second embodiment of the present invention.

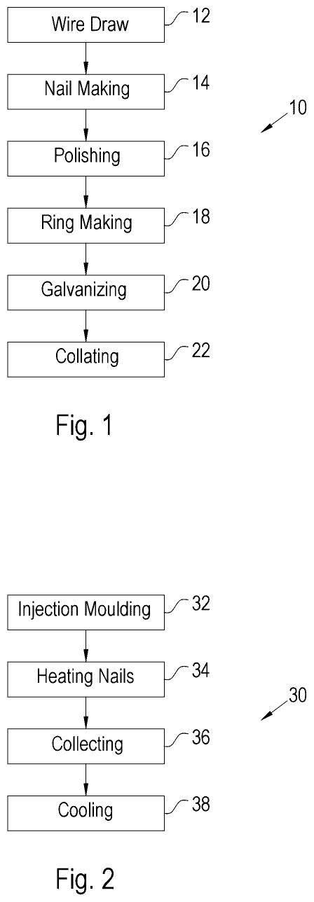

### DETAILED DESCRIPTION OF EXAMPLE EMBODIMENTS

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

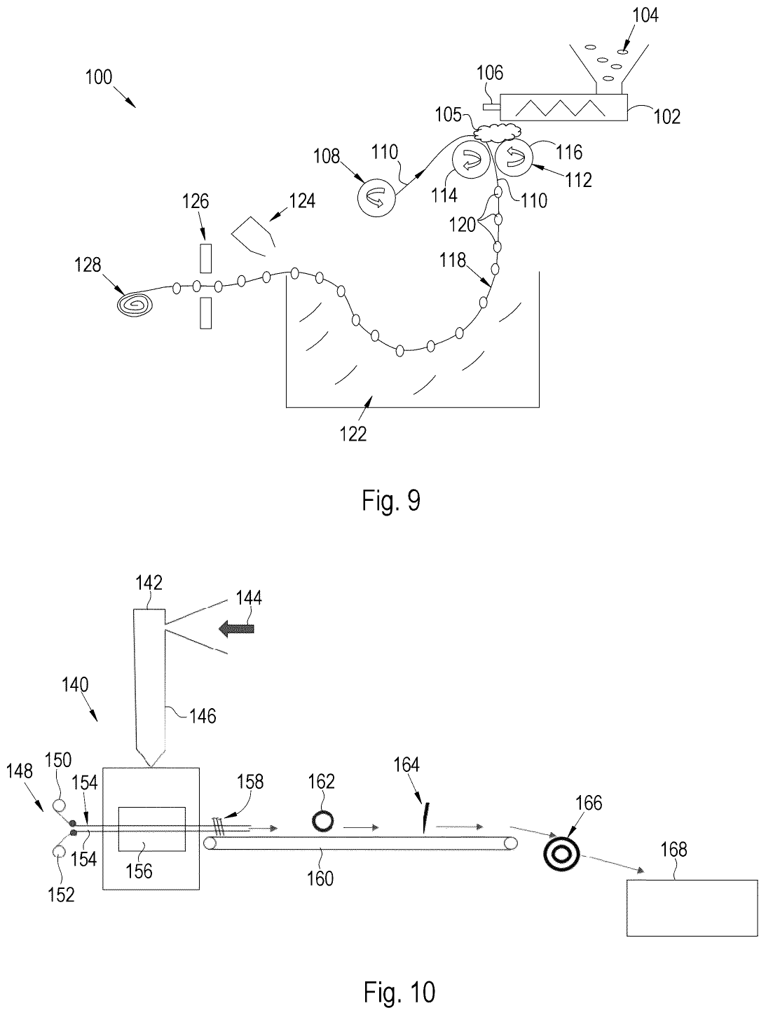

As indicated above, the present invention provides a high compression and withholding strength polymer fastener, and in particular a fibre reinforced polymer nail, which can be screw-threaded or ring-threaded (or be formed with any formation to enhance holding strength). The threading and collation can be done in one single process, for subsequent use in either a loose, strip or coil form. The underlying single process may be either by calendar milling, as will be described in more detail further with reference to FIG. 9, or injection moulding, as will be described in more detail further with reference to FIG. 10, or any other one process method including compressor moulding.

In particular, the present invention presents a fibre reinforced polymer nail manufactured from fibre reinforced polymer with a compression strength of about 30,000 psi (approximately 207 MPa) and a flexural modulus of about 1890 ksi (approximately 13 MPa). The nail is manufactured by using only one key process, and may include the optional additional steps of screw-threading or ring-threading the shank of the nail to increase the nail's withholding strength. Advantageously, as a natural consequence of using polymer, the resulting nail is inherently rust and corrosion resistant. The result is a composite nail that is corrosion and rust-free, with inherent self-extinguishing properties. The nail can be used with an impact automatic tool in a strip or coil form. The single or loose nail can be used in the traditional methods by using a hammer. The single nail can be used within a sleeve example nail in plugs or any other sleeves. The single or loose, coil or strip nail can be used with a washer or seal where it is required.

The fibre reinforced polymer nail can be used in a wide range of wood applications, including pine, teak, and blue gum. Within the construction industry, including the bedding and pallet sectors withholding strength are extremely important. The nail can be used with applications that required the nail to penetrate steel plate and wood, for example, in roof applications. Nails are not limited and can be produced in all pitches required by the available nail machines or tools.

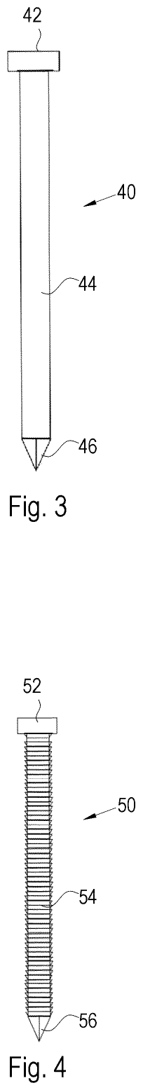

In this regard, FIG. 3 shows a single, unthreaded (i.e. plain or smooth) fibre reinforced nail 40, comprising a head 42 and an unthreaded shank 44 terminating in a pointed end 46. The pointed end 46 may be sharp or blunt, or may be formed into any applicable/required shape.

FIG. 4 shows a single, threaded fibre reinforced nail 50, comprising a head 52, and a threaded shank 54 terminating in a pointed end 56. The thread (which can be either a screw-thread or a ring-thread) shank can start directly under the head 52, to increase the withholding strength of the nail 50. Again, the pointed end 56 may be sharp or blunt, or may be formed into any applicable/required shape.

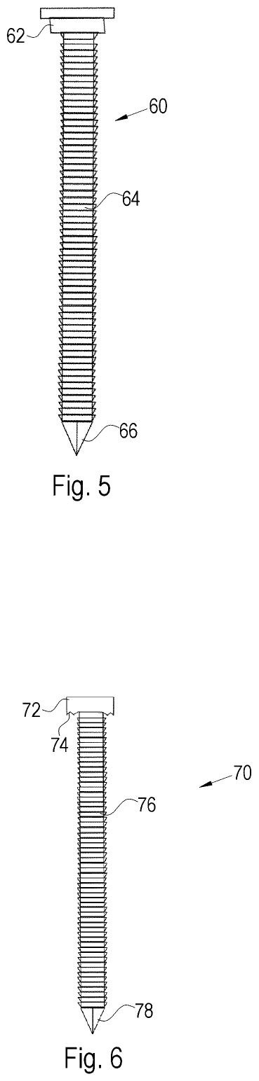

FIG. 5 shows a single, threaded fibre reinforced nail 60, comprising an elevated or raised head 62 to improve the nail's withholding strength, and a threaded shank 64 terminating in a pointed end 66. Again, the pointed end 66 may be sharp or blunt, or may be formed into any applicable/required shape.

FIG. 6 shows a single, threaded fibre reinforced nail 70, comprising a head 72 that is either threaded or includes teeth 74 to improve the nail's withholding strength, and a threaded shank 76 terminating in a pointed end 78. Again, the pointed end 78 may be sharp or blunt, or may be formed into any applicable/required shape.

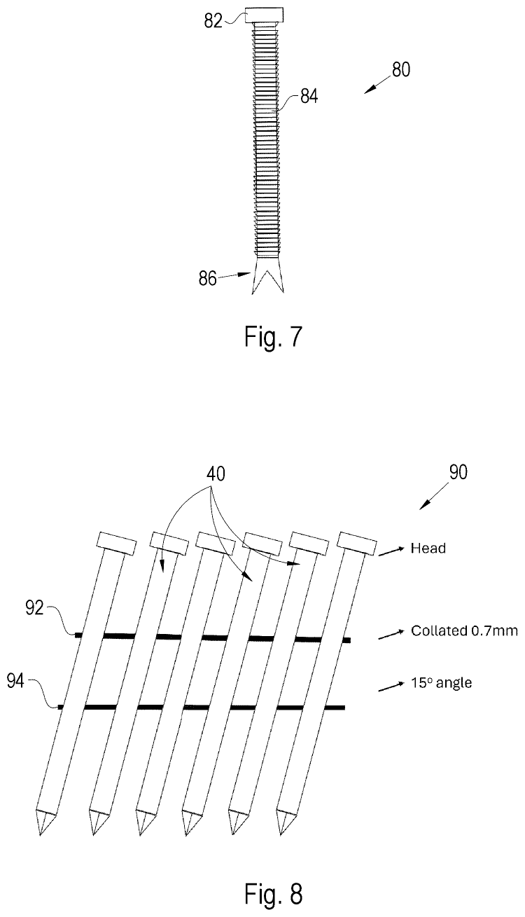

FIG. 7 shows a single, threaded fibre reinforced nail 80, comprising a head 82, and a threaded shank 84 terminating in a split end 86 to increase the nail's withholding strength.

FIG. 8 shows an integrated collated strip 90 of reinforced polymer fasteners of the type defined above, according to a further aspect of the present invention. In this case, the strip 90 of collated nails shows plain nails 40 (of the type shown in FIG. 3), but any of the nails shown in FIGS. 4 to 7 may be collated in a similar manner. The collated nails 90 are assembled or connected using two lines or threads 92, 94, typically spaced approximately between 0.7 mm and 0.8 mm apart, the lines 92, 94 themselves being made from the same or similar material used for the nail 10 itself, or any other suitable material. The connector threads 92, 94 extend transversely across the shanks 44 of each polymer fastener 40, and are arranged to separate the fasteners 90, including the heads 42 of each fastener 40, from each other, to enable the collated strip 90 of polymer fasteners 40 to be used by a conventional nail gun.

The spacing between the fasteners 40 may be smaller or bigger or even almost zero. The nail manufacturing process is not limited to these spacings, and can be spaced as required with the desired pitch. Instead of two distinct lines or threads 92, 94, a single collating block of material may be used.

For coil nails, the nails 40 themselves are typically angled at approximately 15 degrees but can be angled at any other angle as per the requirement of a collated nail tool that will use the strip 90 of collated nails. Strip nails are typically angled at 20 degrees.

Thus, the nails of the present invention can be produced as a plain nail, with head, shank and point, or as a threaded nail which will increase the withholding strength tremendously. The collated nails can be produced in various sizes and diameters, including, but not limited to, 35 mm×2.1 mm and 90 mm×3.15 mm.

Advantageously, calendar milling and injection moulding with a polymer plastic may be used to mould and shape the nails in accordance with any requirement. Therefore, fibre reinforced polymer nails can be shaped with a slightly elevated or threaded head, shank and a split point if required to increase the withholding strength.

In addition, the invention presents a reinforced polymer nail that is assembled within a collation pattern with two single wires or threads, as shown in FIG. 8. The process presents different spacing options to accommodate any collated tool, within the wire (mild steel) or other polymer collated nail tools, including strip nail tools or coil nail tools. The manufacturing process of the nails includes the collation process, all in one production process, and further includes using the same or similar material to assemble the nails in a strip or coil form.

Turning now to FIG. 9, according to a first aspect of a first embodiment of the invention, there is provided an apparatus 100 for and related method of manufacturing a reinforced polymer fastener. The apparatus 100 includes an extruder 102 for extruding raw plastic polymer material 104, typically comprising fibre reinforced polymer pellets, to define an extruded polymer compound 105. Plastic extrusion typically involves melting thermoplastic materials and pressurizing them to force the melt through a die, although in this case, the melted polymer material 105 is extruded through an outlet 106 of the extruder 102.

A collating thread feeder 108 is provided to feed at least one collating thread 110, but typically two spaced apart collating threads 110, towards the extruded polymer compound 105 exiting the extruder 102. The collating thread 110 is made from a polymer compound, typically similar to the extruded polymer compound, or any other suitable material.

A calendar milling roller arrangement 112, comprising rollers 114, 116, to mould the extruded polymer compound 105 onto the collating thread 110 is provided to define a strip 118 of spaced apart polymer fasteners 120 integral with the at least one collating thread 110.

Calendar milling typically involves using a series of hard pressure rollers to finish or smooth various materials, such as paper, textiles, rubber, or plastics, but in this case, the rollers are used to form the fasteners themselves. This is typically done by shaping and/or configuring the surface of the rollers to achieve the required and desired pattern.

In an embodiment, the apparatus 100 includes a water-cooling arrangement 122 to cool the strip 118 of spaced apart polymer fasteners 120 integral with the collating thread 110, and an air dryer 124 to dry the strip 118 of spaced apart polymer fasteners 120 integral with the collating thread 110.

The apparatus 100 further includes a cutting arrangement 126 to cut the strip 118 of spaced apart polymer fasteners 120 integral with the collating thread 110, for subsequent use in either a strip or coil form 128.

In an embodiment, the apparatus 100 and related method are arranged to form plain polymer fasteners, comprising a head, a plain shank and pointed end, and/or threaded polymer fasteners, in which the shank is threaded, and/or raised and threaded polymer fasteners, in which the head is raised relative to a threaded shank, and/or a threaded head polymer fastener, and/or a polymer fastener with a shaped end (opposite the head).

Thus, in this first embodiment, polymer nails will be produced using calendar moulding or milling in combination with an extrusion process to manufacture and assemble the nails. Within the same single process the collated nails will be cut to the required length to fit in a coil or strip tool. The last function within the same process will be to stack the strips together or to roll up the strip in a coil form.

Turning now to FIG. 10, according to a first aspect of a second embodiment of the invention, there is provided an injection moulding apparatus 140 for and related method of manufacturing for forming a collated strip of reinforced polymer fasteners, and in particular a coil nail strip. The apparatus 140 includes a hopper 142 to receive raw plastic polymer material 144, typically comprising fibre reinforced polymer pellets, and an injection moulding housing 146 accommodating a reciprocating barrel and screw for delivering an extruded polymer compound. The apparatus 140 further includes a wire feeder arrangement 148, typically a pair of wire feeders 150, 152, to feed the collating threads 154, as described above.

The apparatus 140 further includes a mould 156 for receiving the extruded polymer compound and the collating threads 154, the mould 156 being arranged to define a strip 158 of spaced apart polymer fasteners integral with the collating threads, as described above.

In an embodiment, the apparatus 140 further includes a product conveyor 160 to transport the moulded strip 158, under a tension wheel 162, towards a cutting arrangement 164 to cut the strip 158. The apparatus 140 further includes a collated nail coiler 166 to coil the cut strip, for packaging 168.

In another version, the mould defines both the polymer fasteners and the interconnecting collating thread. In other words, in this version, there is no need for the wire feeders 150, and the end result is substantially the same, namely an integrally moulded strip of spaced apart polymer fasteners integral with at least one collating thread. This version is better suited for strip nails.

In an embodiment, the injection moulding apparatus and method are arranged to form plain polymer fasteners, comprising a head, a plain shank and pointed end, and/or threaded polymer fasteners, in which the shank is threaded, and/or raised and threaded polymer fasteners, in which the head is raised relative to a threaded shank, and/or a threaded head polymer fastener, and/or a polymer fastener with a shaped end (opposite the head).

Thus, in this second embodiment, reinforced polymer nails will be produced using injection moulding, which can make the nails continuously on the two collating threads. The end result is a stirp of continuous collated nails, which may then be cut and rolled up in a coil or left as a strip so as to be compatible with a coil or strip nail collation tool.

As indicated above, traditional polymer nails are made as separate, loose components, with nails then being inserted into collars that was used to fasten the nails to each other and to form a strip of limited length i.e. typically not longer than 30 mm. The advantage of the present invention is that a continuous of spaced apart polymer fasteners integral with the collating thread may be made, with suitable adjustments being needed to be made to existing calendar milling and injection moulding machines. A typical strip may have an overall length of 2.4 m, comprising 60 mm×2.4 mm collated nails. In the case of injection moulding machines in particular, adjustments will be needed to accommodate the desired 2.4 m overall length.

In terms of strength, the invention presents a fibre reinforced polymer nail that can be used as an alternative to wire nails, in the form of either loose or collated nails. The tensile yield strength of SAE1008, mild steel used within the process of manufacturing wire nails is about 41,300 psi and the composition of the fibre reinforced polymer nail referred to within the invention is about 30,000 psi. The tensile strength of the fibre reinforced polymer nails is acceptable within all wood fastening applications, including applications where blue gum (Eucalyptus globulus—10 550N), Teak (Tectona grandis—4 740N) and Pine wood (Eastern white pine—1 690N) is used. The fibre reinforced polymer nail can also be used within roofing applications where steel metal is attached to wood. The nails of the present invention can be used with or without a sleeve as per requirement of application. For example, a nail in a plug or any other sleeve application may be used, in which the nail opens the sleeve to increase the withholding strength. The nails, whether individually as loose nails, or in strip or coil form can also be used with or without a washer or seal.

The advantages of the present invention include:
Loose nails are made within one process, as an alternative to steel nails, threaded or plain shanks.
Nails can be used within an impact automatic tool or the traditional hammer method.
Nails can be used individually or in strip or coil form, with sleeve or anchor, or with washer or seal or without.
Nails can penetrate wood applications or where wood and metal sheets are used; for example, roof applications that require nails to penetrate wood and metal sheet and use washers to seal the penetration points.
Unlimited head, shank and point design compared to traditional wire nails to increase the withholding strength within applications.
Raw material used to manufacture nails are less expensive, taking the density of reinforced polymer and metal nails into consideration, and the production process is at a lower cost compared to the traditional wire nails.
Collated nails manufactured within one process, starting from nail forming to collated coils or strips that can be used within collated tools, traditional tools including wire collated nail tools.
Unlimited head, shank and point design compared to traditional wire collated nails and current polymer collated nails.
Possibility to extract two collated nails at a time to assist the pallet manufacturing industry.
Raw material used to manufacture nails are at a lower cost considering the density of the reinforced polymer and metal nail fastener and with less production processes, the cost to manufacture is decreased tremendously.
The above presents and innovative product that is an alternative product that can be used within the hardware, bedding, pallet, decking and roofing industry, and for building or house construction framing.
Within a declining economic environment an applicable, lower cost product will assist the hardware, bedding, pallet and roofing industries.
The density of the reinforced polymer product will lead to lower transport costs compared to the metal fastener.

1. A collated strip of polymer fasteners, the collated strip comprising:
a plurality of spaced apart polymer fasteners, each made from a polymer material, each polymer fastener comprising a head and a shank extending therefrom, the shank terminating at an end; and
a connector integrally formed with, and extending transversely across, the shanks of each polymer fastener, the connector being arranged to separate the fasteners, including the heads of each fastener, from each other.

2. The collated strip of polymer fasteners of claim 1, wherein a portion of the shank is threaded, the threaded portion of the shank being either screw-threaded or ring-threaded.

3. The collated strip of polymer fasteners of claim 1, wherein the connector comprises a pair of spaced apart collating threads to integrally connect the shanks of the polymer fasteners together, to define the collated strip of polymer fasteners.

4. The collated strip of polymer fasteners of claim 1, wherein the connector is made from the same polymer material as the polymer fasteners.

5. The collated strip of polymer fasteners of claim 1, wherein the polymer material is fibre reinforced, with each polymer fastener having a compression strength of at least about 30,000 psi (approximately 207 MPa) and a flexural modulus of at least about 1890 ksi (approximately 13 MPa).

6. A method of manufacturing a collated strip of polymer fasteners, the method comprising:
receiving a polymer material;
forming a plurality of spaced apart polymer fasteners from the polymer material, which includes the step of forming a head and forming a shank extending from the head, the shank terminating at an end, to define the polymer fastener; and
integrally forming a connector with the shanks of each polymer fastener, the connector extending transversely across the shanks of each polymer fastener, the connector being arranged to separate the fasteners, including the heads of each fastener, from each other, to enable the collated strip of polymer fasteners to be used by a conventional nail gun.

7. The method of claim 6, wherein the method includes the step of integrally threading at least a portion of the shank of each polymer fastener, the threaded portion of the shank being either screw-threaded or ring-threaded.

8. The method of claim 6, wherein the method includes the step of integrally forming a pair of spaced apart connectors with the shanks of each polymer fastener, to integrally connect the shanks of the polymer fasteners together, to define the collated strip of polymer fasteners.

9. The method of claim 6, wherein the connector is made from the same polymer material as the polymer fasteners.

10. The method of claim 6, wherein the method comprises:
extruding raw plastic fibre reinforced polymer material to define an extruded polymer compound;
receiving at least one collating thread made from a polymer compound, the collating thread defining the connector; and
calendar milling the extruded polymer compound onto the at least one collating thread to define a strip of spaced apart polymer fasteners integral with the at least one collating thread.

11. The method of claim 10, wherein the method includes the steps of water cooling and then air drying the strip of spaced apart polymer fasteners integral with the collating thread, and then cutting the strip of spaced apart polymer fasteners integral with the collating thread, for subsequent use.

12. The method of claim 6, wherein the method comprises injection moulding raw plastic polymer material, using a mould, to define the strip of spaced apart polymer fasteners integral with the connector.

13. The method of claim 12, wherein the mould defines both the polymer fasteners and the connector, to ultimately define an integrally moulded strip of spaced apart polymer fasteners integral with at least one connector.

14. The method of claim 12, wherein the mould only defines the polymer fastener, with the method including the further step of receiving at least one collating thread, which defines the connector, into the mould, with the mould being arranged to integrally mould a strip of spaced apart polymer fasteners integral with at least one collating thread.

15. A single polymer fastener made from a polymer material, each polymer fastener comprising a head and a shank integrally extending from the head, the shank terminating at an end, wherein at least a portion of the shank is threaded, the threaded portion of the shank being either screw-threaded or ring-threaded.

16. The single polymer fastener of claim 15, wherein the polymer material is fibre reinforced, with the polymer fastener having a compression strength of at least about 30,000 psi (approximately 207 MPa) and a flexural modulus of at least about 1890 ksi (approximately 13 MPa).
